(19) United States
(12) Patent Application Publication
(10) Pub. No.: US 2009/0211895 A1
(43) Pub. Date: Aug. 27, 2009

(54) OZONE GENERATOR

(76) Inventors: Peter B. Sewell, Ontario (CA); Richard J. LUSCOMBE-MILLS, Ontario (CA)

Correspondence Address: BIRCH STEWART KOLASCH & BIRCH, PO BOX 747, FALLS CHURCH, VA, 22040-0747, US

(21) Appl. No.: 12/344,101

(22) Filed: Dec. 24, 2008

Related U.S. Application Data
(60) Provisional application No. 61/017,281, filed on Dec. 28, 2007.

(51) Int. Cl. C01B 13/11; B01J 19/08

(52) U.S. Cl. 204/176; 422/186.15

(57) ABSTRACT

An ozone generator includes a dielectric medium with a single continuous wire electrode forming an active corona element being operatively mounted relative to the dielectric medium. A counter-electrode forms a conducting medium in intimate contact with the dielectric medium. Ozone is produced by applying a high frequency, sinusoidal high voltage circuit that is operatively connected to the single continuous wire and the counter-electrode and supplying a voltage thereto.

### BACKGROUND OF THE INVENTION

1. Field of the Invention

An ozone generator is provided with a thin walled glass tube as the dielectric medium. A single continuous wire electrode is the active corona element and the counter-electrode is either a conductor in intimate contact with the glass or a gas plasma which results in a conductive gas as the intimate counter-electrode.

2. Description of Background Art

Various forms of small ozone generators using corona discharge mechanisms are known in the prior art. In most of these devices the corona discharge is initiated by applying a high alternating voltage to an electrode in close contact with a dielectric medium on the other side of which is a large area conducting electrode in intimate contact with the dielectric.

While use of a neon lamp type generator is well established in the industry, all generators of this type evaluated so far, have high voltage active electrodes of a type that do not permit accurate estimation of the amount of ozone produced. Typically they use metal mesh counter electrodes where the total area of active electrode is very difficult to estimate.

### SUMMARY AND OBJECTS OF THE INVENTION

According to an embodiment of the present invention, a specific form of a thin walled glass tube is provided as the dielectric medium. A single continuous wire electrode is the active corona element and the counter-electrode is either a conductor in intimate contact with the glass or a gas plasma which results in a conductive gas as the intimate counter-electrode.

According to an embodiment of the present invention, the devices to be described are considered as small ozone generators, producing ozone from air or oxygen in amounts varying between 0.1 mg/hr to about 100 mg/hr. (mg/hr=milligrams per hour).

According to an embodiment of the present invention, a single wire corona electrode can be fabricated in such a way as to reliably predict that amount of ozone that the generator will produce under specified conditions of operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view illustrating an ozone generator with an active-electrode on the outer surface of a dielectric tube and an internal counter-electrode;

FIG. 2 is a view illustrating an embodiment of a small ozone generator based on a NE-2 neon lamp;

FIG. 3 is a view illustrating two ozone generators arranged adjacent to each other; and

FIG. 4 is a schematic view illustrating an ozone generator with an active-electrode on the inner surface of a dielectric tube.

### DETAILED DESCRIPTION OF THE PREFERRED EMBODIMENTS

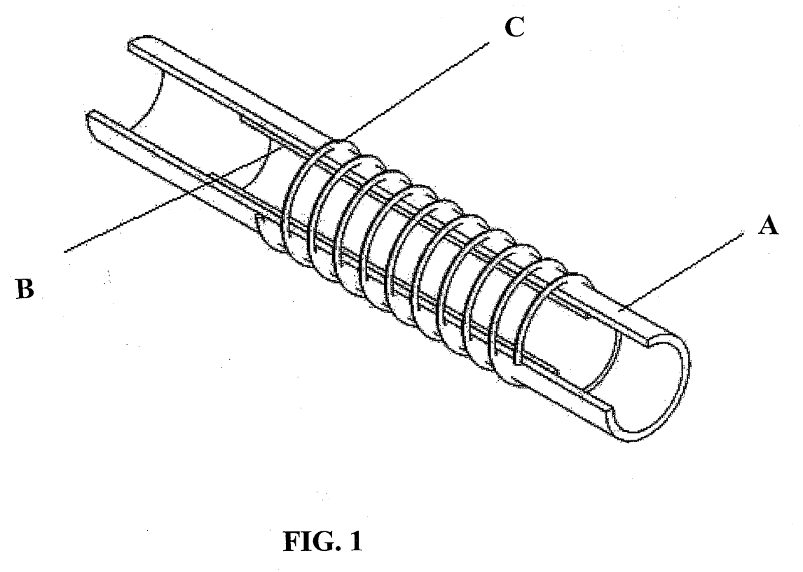

As illustrated in FIG. 1, a glass tube (A) of a specific wall thickness and inner diameter is the dielectric material. The counter-electrode (B) is a conductive film that is in intimate contact with the inner surface of the tube. The active or corona electrode (C) is a spiral wound wire of a refractory metal such as Titanium (Ti) of a specific diameter and of known total length. It is fabricated so as to be in close (but not necessarily intimate) contact with the glass dielectric

A high frequency, sinusoidal high voltage is applied between the electrodes B and C. Typical values would be 10 to 50 kilohertz for the frequency and 1 to 1.5 kilovolts RMS, for the voltage. This results in a corona discharge at the interface between the electrode C and the dielectric A. Ozone is produced in this discharge in an amount that can be measured in terms of mg/hr and the overall output of the device can be described in terms of mg/hr/cm of electrode length. This output is a function of several parameters which include the frequency of the applied voltage, the peak value of the applied voltage, the diameter of the wire electrode, the thickness and dielectric constant of the dielectric and the rate of flow of air or oxygen across (or though) the device.

This device in various configurations can be designed to generate reproducible amount of ozone from 0.1 mg/hr to about 100 mg/hr in dry or moist air or oxygen.

The dielectric for the device illustrated in FIG. 1 is generally a tube of soft or hard glass or silica, with an inner diameter ranging from 0.3 cm to 1 cm and with a wall thickness in the range of 0.5 to 1 mm and with a commonly used value of 0.5 mm. The length of the tube will depend of the number of turns in the spiral electrode and is typically between 1 cm and 15 cm. The glass tube can be open ended or closed at both ends for the purposes of evacuation and backfilling with desirable gases. This will be discussed in more detail in the section describing the counter-electrode C of FIG. 1.

A glass tube is preferred over ceramic materials due to its lower porosity and reduced adsorption of water vapor which is detrimental to the operation of a high voltage corona device.

The counter-electrode as shown in FIG. 1 is a conductive film applied to the inner surface of the glass dielectric. This may be a range of conductive materials such as carbon, silver or other metal compounds generally applied as a continuous film by methods well established in the industry. It may also be a solid metal foil applied by adhesive methods to the inner surface of the tube. Generally this technology is well known and widely used. Electrical contact to this film is made by conventional methods.

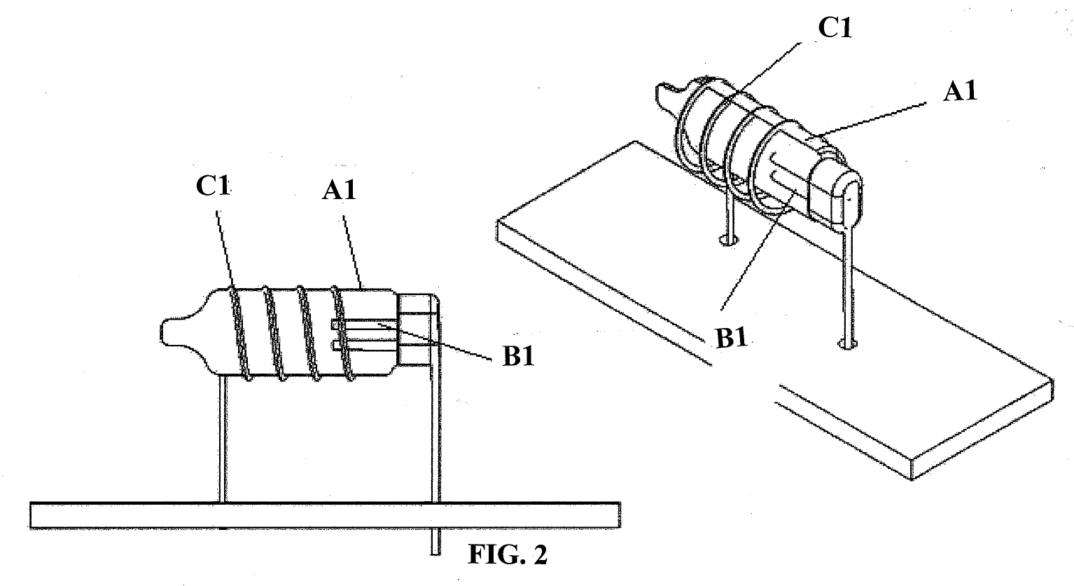

Alternatively, in a sealed tube, the inner counter-electrode may be a gas plasma of the type generated in devices such as small neon pilot lamps and neon signs. The high frequency, high voltage applied to the device excites the gas into the plasma form, which has high electrical conductivity and this plasma, being in intimate contact with the inner surface of the tube, acts as the counter-electrode. External contact with the plasma is made via a glass/metal feed-through as illustrated in FIG. 2. Here a small commercial neon lamp has been modified to act as an ozone generator. The body of the lamp A1 is the glass dielectric, the gas plasma is connected to the high voltage power supply via the glass-metal feed-through B1 and acts as the counter electrode. The active or corona electrode C1 is a few turns of small diameter Titanium wire which in connected to the high voltage supply.

This sealed tube configuration can be used for other purposes such as to protect an internal metal film electrode from oxidation and ion ablation by evacuating the tube or back-filling with a gas at a pressure that is high enough to prevent ionization.

The corona electrode possibly presents the most likely component of the device that may have a potential for a patent claim. We have selected to use a single wire electrode of a refractory metal such as titanium. Other refractory metals are tantalum and niobium. These materials are available in the wire form in the diameter range of about 0.004″ to 0.030″, as used for corona electrodes. These materials and can be wound to form spiral electrodes which maintain their shape and can be positioned easily onto (or into) the tube dielectric.

A property of these materials is that their oxides are highly insulating and the deposition of such oxides on the glass dielectric during operation of the device does not degrade the dielectric properties of the glass. Many other metals would produce conducting or semi-conducting oxide films on the glass during operation, with a resulting reduction in ozone production.

With a single wire corona electrode, the ozone production of the device can be determined accurately by calibration and is proportional to several parameters such as, the diameter of the wire, the length of the wire and the frequency and voltage of the power supply. From calibration, a quantitative estimate of the ozone production can be determined as mg/hr/cm of electrode. Such a number is also determined by the gas environment in which the calibration is conducted. A typical value of 0.5 mg/hr/cm of electrode is measured for a 0.012″ diameter titanium wire on a dielectric of 0.5 mm (0.020″) thickness, with an applied voltage of 1.3 kilovolts RMS at 40 kilohertz. These measurements have been done in air at 70% relative humidity.

In view of the above construction, generators can be designed with predetermined ozone outputs which will be directly proportional to the diameter of the wire and the total length of the wire in the spiral configuration.

Typical configurations for small generators are shown in FIGS. 1 and 2. In a device such as FIG. 2, with a NE-2 neon pilot lamp of diameter 5.6 mm, the length per turn is 1.75 cm and for 4 turns, the total length of the electrode is about 7 cm. The resulting ozone production would be 7 cm×0.5 mg/hr/cm, or 3.5 mg/hr.

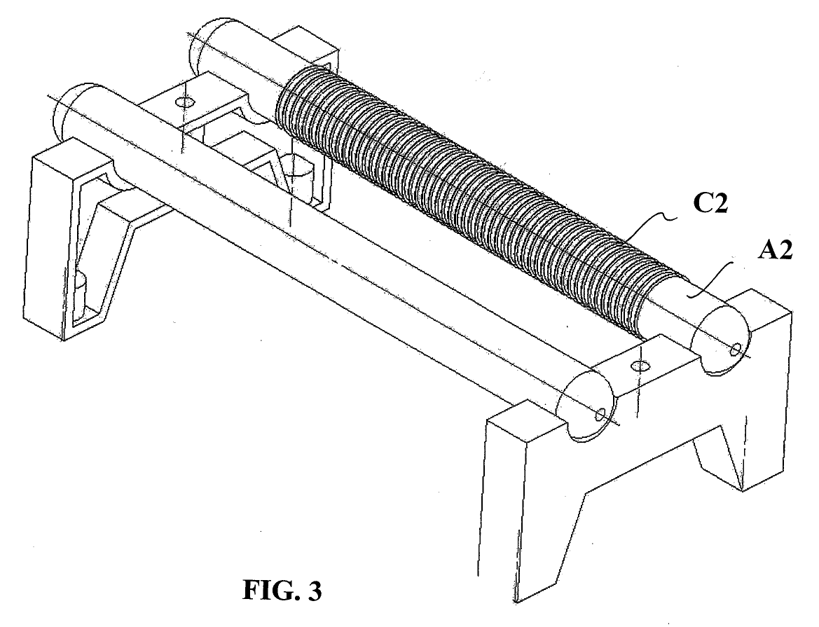

If larger amounts of ozone are required, the length of the electrode can be increased by increasing the diameter of the glass dielectric tube A and increasing its length and the number of turns used for the electrode. For a tube A2 having a diameter of 1.2 cm, the length per turn C2 is 3.77 cm and for 55 turns the electrode length would be about 207 cm. As shown in FIG. 3 such a device would produce about 103.5 mg/hr under the condition mentioned above for 0.5 mg/hr/cm. Such devices can be mounted in parallel as shown in FIG. 3 to create products with larger ozone production.

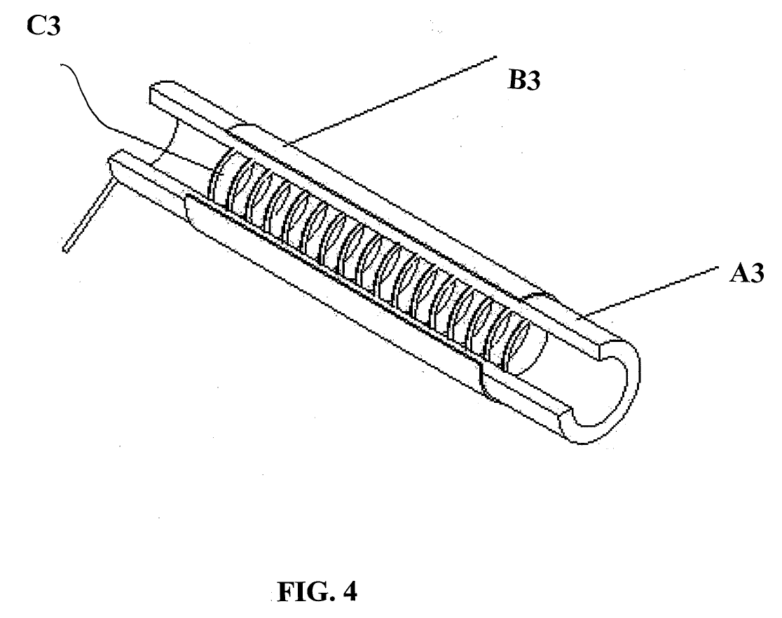

An alternative configuration for all these tubular devices is that shown in FIG. 4 wherein the dielectric A3 is of the same type as that shown in FIG. 1, however the counter-electrode B3 is on the outer surface of the glass tube and the active or corona-electrode C3 is on the inside. This electrode is wound in such a way that on insertion into the tube, it springs out to form close contact with the inner surface of the glass dielectric. Voltages are applied between the electrodes B3 and C3 as described previously and the ozone is produced within the tube. This type of arrangement doesn't allow for the plasma type counter-electrode described earlier. However, it enables gas to be directed through the tube in such a way that the ozone produced can be confined by external tubing and delivered to specific applications. Tube structures of this type can also be made for ozone outputs ranging from about 0.1 mg/hr to 100 mg/hr.

An advantage of this configuration is that the counter-electrode which is usually at ground potential can be readily cooled by heat sinking of some form, thus allowing for high ozone output without overheating of the device.

The present invention permits the use of a single continuous wire of small diameter and of a refractory metal as the Active or Corona Electrode in a small ozone generating device with an output of between 0.1 and 100 mg/hr.

The use of such an electrode may be on the outer surface of a thin walled glass tube dielectric medium, with an opposing counter-electrode as either a continuous metallic conductor or a gas plasma.

The present invention may use alternating high voltage with a sinusoidal wave form and a low peak voltage generally less than 2 kilovolts, which minimizes the possibility of a high voltage breakdown of the dielectric medium. This is a common problem in higher voltage ozone generators.

In addition, the present invention permits the use of electrical drive parameters and electrode design that limit the maximum ozone production to less that 1 mg/hr/cm of electrode length and thus eliminate the need for forced cooling of the generator device.

The present invention uses either a single wire spiral electrode or multiple straight electrodes of a specific diameter and total electrode length, where it has been established that the mg/hr of ozone produced is a function of:

(i) The applied AC voltage and frequency,

(ii) the wire diameter, and

(iii) the total wire length.

As ozone generator according to an embodiment of the present invention can be designed to produce ozone in well quantified amounts, generally in the range of 0.1 to 100 mg/hr.

The Active Electrode: This has been specifically selected so that oxidation products developed during operation have little or no effect on the surface conductivity of the glass dielectric and do not alter the overall dielectric properties. Metals suitable for this purpose are:

titanium, tantalum, niobium and aluminum and alloys containing various percentages of these metals.

The wire diameter of the active electrode determines the local electric field around the electrode and hence the voltage at which the electrode will produce ozone. Electrode diameters according to the present invention are in the range of 4 mils to 30 mils, this range being selected for the production of low amounts of ozone in mg/hr with the low voltages and high frequencies used in the generator power supplies.

For wire of a specific diameter used with a known applied voltage, the amount of ozone produced is a function of the total length of the electrode.

Generator Configurations

Generator using a commercial NE-2 type neon lamp which includes an active electrode that is wound or mounted on the external surface of the lamp and a counter electrode which is provided by the surface conductivity of the internal surface of the lamp, as developed by the gas discharge.

FIG. 2 illustrates two views of a small ozone generator with spiral wound electrodes C1 mounted on an NE-2 neon lamp A1 with B1 being contacts to the internal gas.

A similar general configuration is illustrated in FIG. 3 wherein a thin walled glass cylinder A2 is used as the dielectric and the active electrode C2 is wound on the outer surface of the device. The internal counter electrode for this device is a conductive film on the inside surface of the glass cylinder, this is connected to the external circuit.

Mounting configurations for the above embodiments might be included such as the plug-in type of mount to be used according to the present invention.

An arrangement similar to B discussed above may be used wherein the active refractory metal wire electrode is wound in such a way that it is sprung out and compressed against the internal surface. In this case, the counter electrode is a conductive metal film on the outside surface of the glass cylinder. This device has the advantage that the gas to be used for ozone production, such as air or pure oxygen, can be passed through the ozone generator in controlled quantities and the resulting ozone piped to its point of application. In addition, this arrangement permits the cooling of the device via an earthed counter electrode in the form of an appropriate heat sink.

Other embodiments of the present invention may include tubes of larger diameter with higher applied voltages and electrodes of greater length wherein the ozone production can be increased from values around 10 mg/hr to unit producing some 100 mg/hr or more, as will be required for alternative application of ozone for both air and water treatment.

The ozone dispersion from embodiments of small devices according to the present invention is based on atmospheric diffusion rather than forced air flow, thus reducing the rate of contamination of the generators. For larger generators, forced air circulation may be used to prevent overheating of the devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ozone generator comprising:
a dielectric medium;
a single continuous wire electrode forming an active corona element;
a counter-electrode forming a conductor in intimate contact with the dielectric medium;
a high frequency, sinusoidal high voltage circuit operatively connected to the single continuous wire and the counter-electrode for supplying a voltage for producing ozone.

2. The ozone generator according to claim 1, wherein the dielectric medium is a thin glass tube.

3. The ozone generator according to claim 1, wherein contained within the dielectric medium is gas plasma.

4. The ozone generator according to claim 1, wherein the single continuous wire is made of titanium.

5. The ozone generator according to claim 1, wherein ozone is produced from air or oxygen in amounts varying between 0.1 mg/hr to about 100 mg/hr. (mg/hr=milligrams per hour).

6. A method of generating ozone comprising the following steps:
providing a dielectric medium;
providing a single continuous wire electrode forming an active corona element;
providing a conducting counter-electrode in intimate contact with the dielectric medium;
applying a high frequency, sinusoidal high voltage circuit operatively connected to the single continuous wire and the counter-electrode for supplying a voltage for producing ozone.

7. The method of generating ozone according to claim 6, wherein the dielectric medium is a thin glass tube.

8. The method of generating ozone according to claim 6, wherein adjacent to or contained within the dielectric medium is gas plasma.

9. The method of generating ozone according to claim 6, wherein the single continuous wire is made of titanium or another refractory or alternatively aluminum;
alternatively: titanium or another metal which has a similar highly insulating oxide.

10. The method of generating ozone according to claim 6, wherein ozone is produced from air or oxygen in amounts varying between 0.1 mg/hr to about 100 mg/hr. (mg/hr=milligrams per hour).
